(19) United States
(12) Patent Application Publication
(10) Pub. No.: US 2015/0032350 A1
(43) Pub. Date: Jan. 29, 2015

(54) SYSTEM AND METHOD FOR REDUCING WEAR DURING BUILD-UP OF ENGINE TORQUE

(71) Applicant: Scania CV AB, Södertälje (SE)

(72) Inventors: Karl Redbrandt, Solna (SE); Mikael Wågberg, Enhorna (SE)

(21) Appl. No.: 14/382,588

(22) PCT Filed: Feb. 26, 2013
(86) PCT No.: PCT/SE2013/050170

§ 371 Date: Sep. 3, 2014

(30) Foreign Application Priority Data
Mar. 28, 2012 (SE) 1250303-3

(51) Int. Cl. B60W 10/02; B60W 10/04; F16D 48/06

(52) U.S. Cl. CPC B60W 10/02; F16D 48/06; B60W 10/04
USPC 701/68

(57) ABSTRACT

A method for wear-limiting torque build-up in a vehicle (100; 110) provided with an engine (230), a clutch configuration (235) and a gearbox (240). The method has steps of demanding (s410) a power train torque; guiding (s420) the torque build-up towards the power train torque demanded (Tqreq); responding to continuing torque build-up at a certain engine speed (Es) by only providing a reduced power train torque (Tqlimit) which is less than a maximum available engine torque (Tqmax); continuously deciding (s450) whether the vehicle is moving or not; then either further increasing the power train torque (Tq) by increasing the engine's speed (Es) if the prevailing power train torque (Tq) is substantially the same as the reduced power train torque (Tqlimit) and the vehicle (100) is not moving, or automatically activating (s460) the clutch configuration (235) to non-slipping operation if the prevailing power train torque is substantially the same as the reduced power train torque and the vehicle is not moving.

### TECHNICAL FIELD

The present invention relates to a method for wear-limiting torque build-up in a vehicle. The invention relates also to a computer programme product comprising programme code for a computer for implementing a method according to the invention. The invention relates also to a device for wear-limiting torque build-up in a vehicle, and to a motor vehicle equipped with the device.

### BACKGROUND

Certain vehicles used for example in plant operations or in mining or quarrying may be subject to loading and unloading of cargo at frequent intervals. In such situations it often happens that the running resistance changes drastically. If a moving-off procedure is not robust enough to cope with large changes in running resistance, a clutch in the vehicle's power train may suffer a great deal of wear when the vehicle is being set in motion from stationary. Alternatively, a situation where the vehicle cannot be accelerated may arise. For a control system of the vehicle to be robust enough to cope with being incorrectly handled by an inexperienced driver, the moving-off procedure needs to be as independent as possible of driver inputs to the system.

There are currently existing solutions whereby a driver can manually set a raised engine speed for a vehicle moving off uphill or carrying a heavy unknown cargo load. These solutions may be both troublesome and complex for an unaccustomed driver, and even if risk of the engine stalling is reduced there remain problems related to unacceptable component wear in the vehicle's power train.

U.S. Pat. No. 7,979,191 describes a system for making it easier to set a vehicle in motion in challenging operating situations.

### SUMMARY OF THE INVENTION

One object of the present invention is to propose a novel and advantageous method for wear-limiting torque build-up in a vehicle.

Another object of the invention is to propose a novel and advantageous device and a novel and advantageous computer programme for wear-limiting torque build-up in a vehicle.

A further object of the invention is to propose a method, a device and a computer programme for achieving a more user-friendly way of setting a motor vehicle in motion from stationary.

A further object of the invention is to propose an alternative method, an alternative device and an alternative computer programme for wear-limiting torque build-up in a vehicle.

These objects are achieved with a method for wear-limiting torque build-up in a vehicle provided with an engine, clutch configuration and gearbox according to claim 1.

One aspect of the invention is a proposed method for wear-limiting torque build-up in a vehicle provided with an engine, clutch configuration and gearbox, comprising the steps of
demanding a power train torque,
guiding the torque build-up towards the power train torque thus demanded,
responding to continuing torque build-up at a certain engine speed by only providing a reduced power train torque which is less than a maximum available engine torque,
continuously deciding whether the vehicle is moving or not,
further increasing the engine's speed if the prevailing power train torque is substantially the same as the reduced power train torque and the vehicle is not moving,
automatically activating said clutch configuration to non-slipping operation.

According to the invention, the engine's speed is not increased so long as the prevailing power train torque is less than the reduced power train torque, but torque build-up will instead take place over time with no change in the speed. Only when the prevailing power train torque is substantially equal to the reduced power train torque will the speed increase further and continued torque build-up may take place.

In one aspect of the invention, no raising of the engine's speed will be effected when it is found possible in a suitable desirable way to activate said clutch configuration to non-slipping operation within a reasonable time or with a reasonable amount of wear on said clutch configuration.

A method which is robust in not being affected by incorrect measurements or calculations of, for example, a gradient of the surface on which the vehicle is travelling or the weight of the vehicle is thus with advantage achieved.

A method for wear-limiting torque build-up in a vehicle whereby wear on a clutch configuration is minimised when the vehicle is being set in motion from stationary is thus with advantage achieved. Unnecessarily serious wear on the clutch configuration may be avoided by conducting torque build-up at a relatively low engine speed, e.g. an idling speed, and gradually increasing torque build-up in a way limited according to the invention with controlled speed increase until the vehicle can move.

Said certain speed is a low speed within a predetermined range which may be defined as being between an idling speed of the engine and a lowest engine speed at which a highest engine torque can be provided, e.g. between 500 and 1200 rpm. Torque build-up is thus only allowed initially at an engine speed which is low relative to a speed which prevails during normal operation of the vehicle, with the result that rotation of the shafts which constitute the power train is kept to a minimum. Said certain speed may be an idling speed of said engine.

The method may further comprise the step of
providing said reduced power train torque on the basis of a predetermined relationship between it and said maximum available engine torque. The result is an automated procedure which is both user-friendly and protective of components.

The method may alternatively comprise the step of
providing said reduced power train torque on the basis of a dynamic relationship between it and said maximum available engine torque. Said relationship may be generated continuously by a control unit of the vehicle on the basis of a prevailing operating state of the vehicle. A versatile method for wear limitation during torque build-up in a vehicle may thus be achieved.

The available engine torque may be limited both statically and dynamically. Limitation of the engine torque means that the greatest torque available at a certain speed is less than the maximum torque which the engine can provide. In static limitation of the torque, the difference between the engine's maximum torque and that which is available does not vary over time. An example of static limitation is if in a certain gear the gearbox control unit allows only a certain engine torque to be provided, since the engine's maximum torque might cause damage to gearbox components. Similar limitations may come from, for example, the clutch control unit. Dynamic limitation means that the difference between the engine's maximum torque and the torque available at a certain engine speed varies over time. One example of such a limiter is a smoke limiter, which limits the amount of propellant injected into the engine, and consequently also the torque which the engine can deliver, with the object of controlling the amount of emissions from the vehicle. The maximum available engine torque may itself be further limited to provide a safety margin.

The method may comprise setting said vehicle in motion from stationary. As a driver of the vehicle need not effect any extra settings of, for example, a prevailing cargo load, the result is a user-friendly method according to the invention. It may be difficult for an unaccustomed driver to demand a suitable power train torque when setting in motion from stationary a vehicle which is carrying an unknown cargo load. Problems of this kind are reduced by employing the innovative method.

The method is easy to implement in existing motor vehicles. Software for wear-limiting torque build-up in a vehicle according to the invention may be installed in a control unit of the vehicle during the manufacture of the vehicle. A purchaser of the vehicle may thus have the possibility of selecting the function of the method as an option. Alternatively, software which comprises programme code for conducting the innovative method for wear-limiting torque build-up in a vehicle may be installed in a control unit of the vehicle on the occasion of upgrading at a service station, in which case the software may be loaded into a memory in the control unit. Implementing the innovative method is therefore cost-effective, particularly since no further components or devices need be installed in the vehicle. Relevant hardware is currently already provided in the vehicle. The invention thus represents a cost-effective solution to the problems indicated above.

Software which comprises programme code for wear-limiting torque build-up in a vehicle is easy to update or replace. Moreover, different parts of the software which comprises programme code for wear-limiting torque build-up in a vehicle may be replaced independently of one another. This modular configuration is advantageous from a maintenance perspective.

One aspect of the invention is a proposed device for wear-limiting torque build-up in a vehicle provided with an engine, clutch configuration and gearbox. The device comprises
means for demanding a power train torque,
means for guiding the torque build-up towards the power train torque thus demanded,
means for responding to continuing torque build-up at a certain engine speed by only providing a reduced power train torque which is less than a maximum available engine torque,
means for continuously deciding whether the vehicle is moving or not,
means for further increasing the power train torque by increasing the engine's speed if the prevailing power train torque is substantially the same as the reduced power train torque and the vehicle is not moving,
means for automatically activating said clutch configuration to non-slipping operation.

In the case of the device, said certain speed may be a relatively low speed within a predetermined range, e.g. 500-1200 rpm.

In the case of the device, said certain speed may be an idling speed of said engine.

The device may comprise
means for providing said reduced power train torque on the basis of a predetermined relationship between it and said maximum available engine torque.

The device may comprise
means for providing said reduced power train torque on the basis of a dynamic relationship between it and said maximum available engine torque.

The above objects are also achieved with a motor vehicle which comprises features of the device for wear-limiting torque build-up as above. The vehicle may be a truck, bus or car.

One aspect of the invention is a proposed computer programme for wear-limiting torque build-up in a vehicle provided with an engine, clutch configuration and gearbox, which programme comprises programme code stored on a computer-readable medium for causing an electronic control unit or another computer connected to the electronic control unit to perform steps according to any one of claims 1-6.

One aspect of the invention is a proposed computer programme for wear-limiting torque build-up in a vehicle provided with an engine, clutch configuration and gearbox, which programme comprises programme code for causing an electronic control unit or another computer connected to the electronic control unit to perform steps according to any one of claims 1-6.

One aspect of the invention is a proposed computer programme product comprising a programme code stored on a computer-readable medium for performing method steps according to any one of claims 1-6 when said computer programme is run on an electronic control unit or another computer connected to the electronic control unit.

Further objects, advantages and novel features of the present invention will become apparent to one skilled in the art from the following details, and also by putting the invention into practice. Whereas the invention is described below, it should be noted that it is not confined to the specific details described. One skilled in the art having access to the teachings herein will recognise further applications, modifications and incorporations within other fields, which are within the scope of the invention.

### BRIEF DESCRIPTION OF THE DRAWINGS

For fuller understanding of the present invention and its further objects and advantages, the detailed description set out below should be read in conjunction with the accompanying drawings, in which the same reference notations pertain to similar items in the various diagrams and

FIG. 1 schematically illustrates a vehicle according to an embodiment of the invention,

FIG. 2 schematically illustrates a subsystem of the vehicle depicted in FIG. 1, according to an embodiment of the invention,

FIG. 3 is a schematic diagram according to an embodiment of the invention,

FIG. 4a is a schematic flowchart of a method according to an embodiment of the invention,

FIG. 4b is a more detailed schematic flowchart of a method according to an embodiment of the invention, and

FIG. 5 schematically illustrates a computer according to an embodiment of the invention.

### DETAILED DESCRIPTION OF THE DRAWINGS

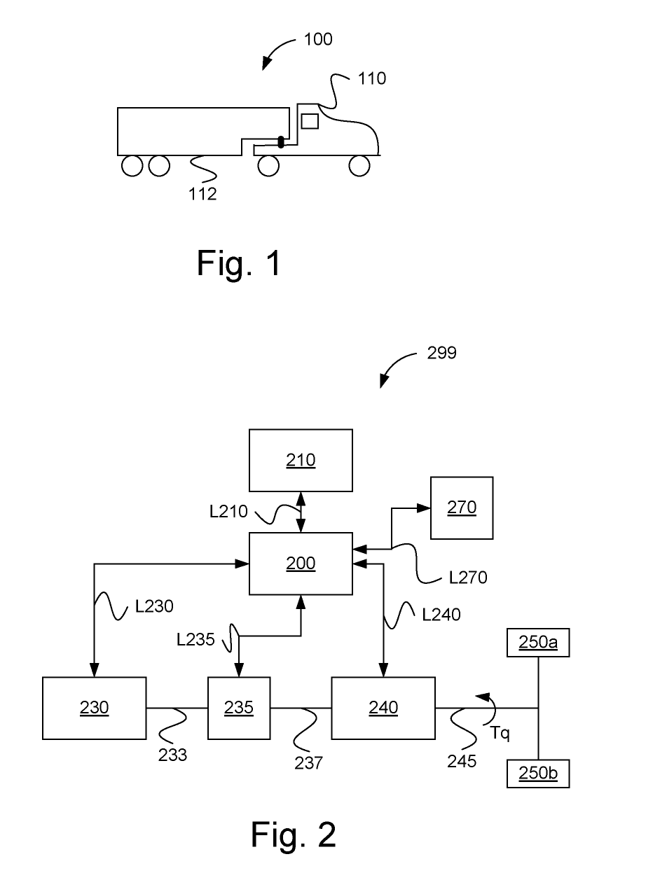

FIG. 1 depicts a side view of a vehicle 100. The vehicle here exemplified comprises a tractor unit 110 and a trailer 112. It may be a heavy vehicle, e.g. a truck or a bus. It may alternatively be a car.

The term “link” refers herein to a communication link which may be a physical connection such as an opto-electronic communication line, or a non-physical connection such as a wireless connection, e.g. a radio link or microwave link.

FIG. 2 depicts a subsystem 299 of the vehicle 100. The subsystem is situated in the tractor unit 110.

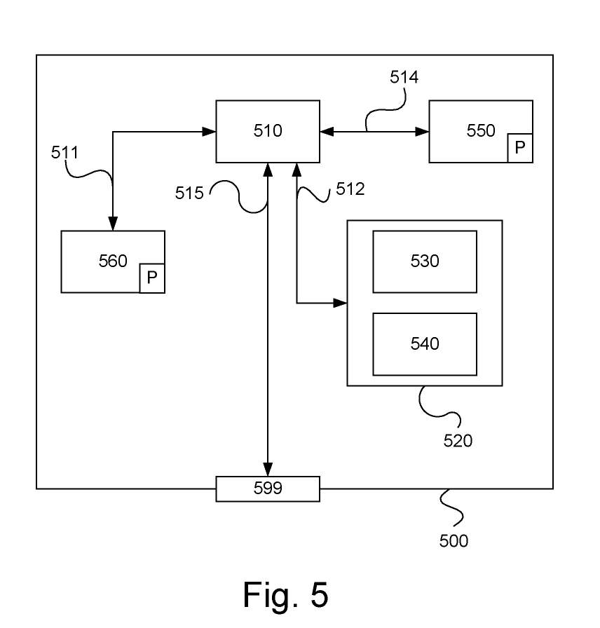

The subsystem 299 comprises a first control unit 200 which may comprise a device described in more detail with reference to FIG. 5.

The subsystem 299 comprises an engine 230 which may be a combustion engine. It may be a diesel engine with a suitable number of cylinders.

The engine 230 is adapted to conveying a torque generated to a clutch configuration 235 via a rotatably journalled shaft 233. The clutch configuration is adapted to transmitting torque in a controlled way to an automatically operated gearbox 240 via a rotatably journalled shaft 237. The clutch configuration may in one version be a disc clutch. The gearbox 240 is adapted to transmitting a torque Tq via an output shaft 245 to tractive wheels 250a and 250b of the vehicle.

The first control unit 200 is provided with communication with the engine 230 via a link L230 and is adapted to controlling the operation of the engine according to control routines stored in a memory of said control unit.

The first control unit 200 is provided with communication with the clutch configuration 235 via a link L235 and is adapted to controlling the operation of the clutch configuration according to control routines stored in a memory of said control unit.

The first control unit 200 is provided with communication with the gearbox 240 via a link L240 and is adapted to controlling the operation of the gearbox according to control routines stored in a memory of said control unit.

The device 299 comprises a pedal system 270 which may be a two-pedal system comprising a brake pedal and an accelerator pedal. The pedal system is signal-connected to the first control unit by means of a link L270. A driver may use the accelerator pedal to demand a power train torque Tq.

The first control unit 200 is adapted to guiding the torque build-up towards a power train torque demanded. When at a certain engine speed there is continuous torque build-up, said first control unit is adapted to only providing a reduced power train torque which is less than a maximum available engine torque. It is adapted to continuously deciding whether the vehicle is moving or not. It is adapted to further increasing the power train torque by increasing the engine's speed if the prevailing power train torque is substantially the same as the reduced power train torque and the vehicle is not moving. It is adapted to automatically activating said clutch configuration to non-slipping operation. It is adapted to providing said power train torque on the basis of a predetermined relationship between the reduced power train torque and said maximum available engine torque. It is adapted to providing said power train torque on the basis of a dynamic relationship between the reduced power train torque and said maximum available engine torque.

A second control unit 210 is provided with communication with the first control unit 200 via a link L210. Said second control unit may be detachably connected to the first control unit. It may be situated externally to the vehicle 100. It may be adapted to performing the innovative method steps according to the invention. It may be used to crossload software to the first control unit, particularly software for conducting the innovative method. It may alternatively be provided with communication with the first control unit via an internal network of the vehicle. It may be adapted to performing substantially similar functions to the first control unit, e.g. using the signals received which contain information about a power train torque demanded Tqreq as a basis for controlling torque build-up in the vehicle's power train according to the innovative method.

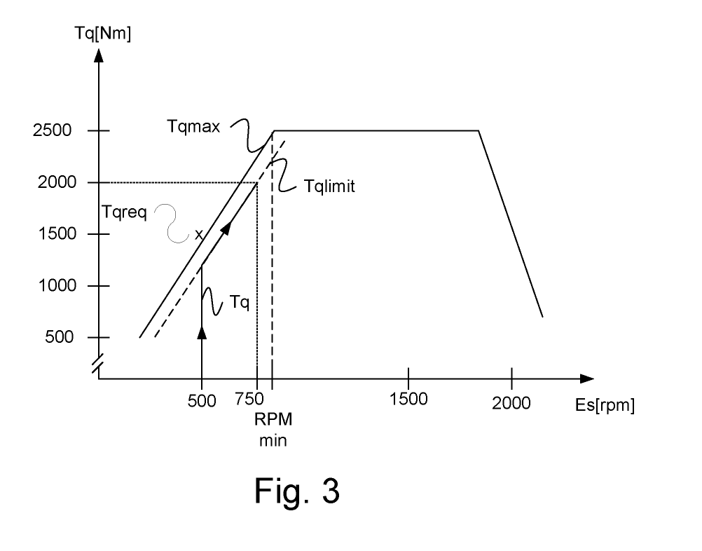

FIG. 3 illustrates schematically a pattern of torque build-up of the vehicle 100, according to an aspect of the present invention. It shows how a maximum available engine torque Tqmax and a prevailing power train torque Tq of the vehicle depend on the speed Es of the engine 230.

This example illustrates said vehicle 100 being set in motion from stationary by a driver using the pedal system 270 to demand a power train torque Tqreq, which may be greater than a maximum available engine torque Tqmax at a prevailing engine speed. The vehicle's engine 230 is in this case running at an idling speed which in this example is 500 rpm.

The engine's maximum available engine torque Tqmax is predetermined and depends on design parameters. Information about Tqmax as a function of the engine's speed may be stored in a memory of the control unit 200.

Build-up of power train torque Tq here takes place in a controlled way according to control routines stored in the first control unit. The build-up of power train torque Tq takes place at the idling speed.

If power train torque is demanded at an engine speed which is higher than the idling speed, e.g. 700 rpm, torque build-up will be controlled at said higher engine speed.

In this first phase, torque build-up will take place at a substantially constant engine speed.

A predefined limit function for torque build-up is referred to in this example as Tqlimit, which may be a function which depends on said maximum available engine torque Tqmax, e.g. 90% of the value of Tqmax at each given engine speed. Tqlimit may for example be 95% of the value of Tqmax at each given engine speed.

Tqlimit may be chosen to a function which is appropriate to the purpose of the torque build-up. It is lower than Tqmax at each given engine speed.

When the torque build-up reaches said limit Tqlimit, the engine's speed Es may be progressively raised to allow a continued torque build-up which is limited upwards by said limit function Tqlimit.

During said torque build-up, it is continuously decided whether a torque transfer in the clutch configuration 235 causes the vehicle to move. If despite engine speed raising and consequent power train torque raising the vehicle remains stationary, further engine speed raising and consequent power train torque raising will be effected until the vehicle begins to move. When it is found that the vehicle is moving fast enough for it to be possible for the clutch configuration to be closed without causing too much discomfort, e.g. when the shafts 233 and 237 are rotating at substantially the same speed, the clutch configuration will be closed completely, resulting in full torque transfer in said clutch configuration. If said clutch configuration is a disc clutch, this corresponds to a state in which the discs have slipped together, i.e. they have substantially no relative movement.

In this example it is found that the vehicle begins to move at 750 rpm, corresponding to 2000 Nm, whereupon the clutch configuration closes completely.

With advantage, a “surplus” of engine speed Es is applied when the clutch configuration closes completely. This surplus may be provided substantially immediately to accelerate the vehicle after the clutch configuration has closed completely.

FIG. 3 indicates a lowest engine speed RPMmin at which a highest engine torque can be provided.

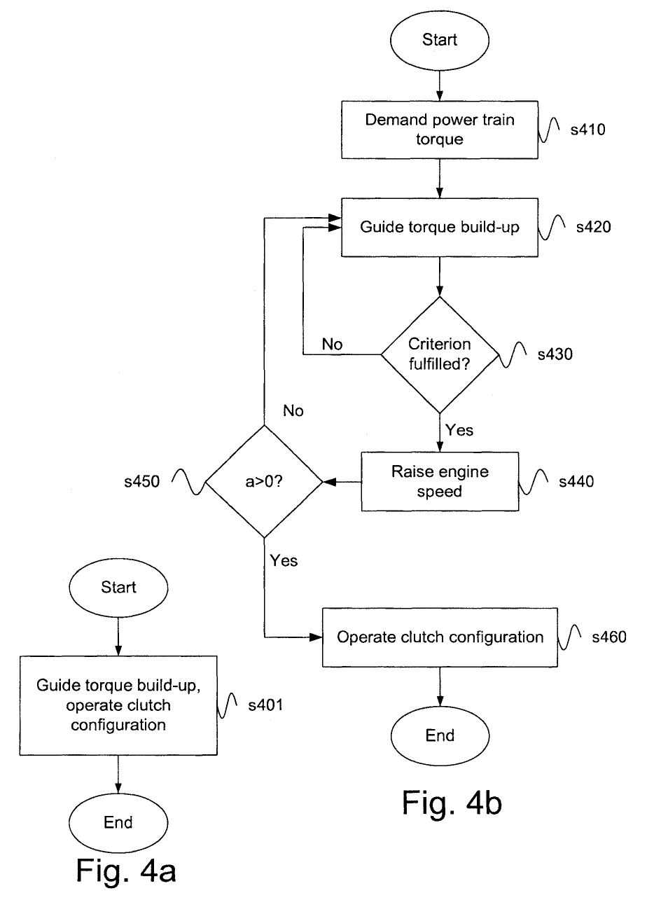

FIG. 4a is a schematic flowchart of a method for wear-limiting torque build-up in a vehicle 100 provided with an engine 230, clutch configuration 235 and gearbox 240, according to an embodiment of the invention. The method comprises a first step s401 comprising the steps of
demanding a power train torque,
guiding the torque build-up towards the power train torque thus demanded,
responding to continuing torque build-up at a certain engine speed by only providing a reduced power train torque which is less than a maximum available engine torque,
continuously deciding whether the vehicle is moving or not,
further increasing the power train toque by increasing the engine's speed if the prevailing power train torque is substantially the same as the reduced power train torque and the vehicle is not moving,
automatically activating said clutch configuration to non-slipping operation.
   The method ends after step s401.

FIG. 4b is a schematic flowchart of a method for wear-limiting torque build-up in a vehicle 100 provided with an engine 230, clutch configuration 235 and gearbox 240, according to an embodiment of the invention.

The method comprises a first step s410 comprising the step of demanding a power train torque Tqreq, which may be by means of the pedal system 270, e.g. by a driver of the vehicle depressing an accelerator pedal. Step s410 is followed by a step s420.

Method step s420 comprises the step of guiding the torque build-up towards the power train torque Tqreq thus demanded, which takes place at a certain engine speed which may be an idling speed, e.g. 500 rpm. Guiding the torque build-up towards the power train torque Tqreq thus demanded thus takes place at a substantially constant engine speed. Step s420 is followed by a step s430.

Method step s430 comprises the step of determining whether a certain criterion is fulfilled or not. Said criterion may comprise information about a reduced power train torque Tqlimit which at a prevailing engine speed is less than a maximum available engine torque Tqmax. If said reduced power train torque Tqlimit is reached, a subsequent step s440 is performed. If it is not reached, step s420 is performed again. Torque build-up will thus be guided towards said reduced power train torque Tqlimit of the vehicle. Tqlimit is described in more detail with reference to FIG. 3. Step s430 is followed by a step s440.

Method step s440 comprises the step of further increasing the torque build-up by increasing the engine's speed Es. Said increase in the engine's speed may be conducted in a controlled way according to routines stored in the first control unit 200.

In one example the engine's speed (and consequently the power train torque Tq) may be increased intermittently in predetermined steps. After such a step, a subsequent method step s450 may be performed.

In another example the engine's speed (and consequently the power train torque Tq) may be increased continuously, in which case it may continuously be decided whether the vehicle has begun to move according to step s450.

Method step s450 comprises the step of deciding whether the vehicle 100 is moving or not, which may be done in various ways. In one example, whether the vehicle is moving forwards (or rearwards) may be determined by angle sensors adapted to determining a vehicle acceleration a. If said acceleration is greater than zero (0), it may be found that the vehicle is moving and a subsequent method step s460 may be performed. If said acceleration is zero (0), it may be found that the vehicle is not moving and method step s420 may be performed again.

Method step s460 comprises the step of automatically operating the clutch configuration 235. It may comprise the step of automatically activating said clutch configuration to non-slipping operation, in which case the power train of the vehicle is closed completely by said clutch configuration. The method ends after step s460.

FIG. 5 is a diagram of a version of a device 500. The control units 200 and 210 described with reference to FIG. 2 may in one version comprise the device 500. The device 500 comprises a non-volatile memory 520, a data processing unit 510 and a read/write memory 550. The non-volatile memory 520 has a first memory element 530 in which a computer programme, e.g. an operating system, is stored for controlling the function of the device 500. The device 500 further comprises a bus controller, a serial communication port, I/O means, an A/D converter, a time and date input and transfer unit, an event counter and an interruption controller (not depicted). The non-volatile memory 520 has also a second memory element 540.

A proposed computer programme P comprises routines for wear-limiting torque build-up in a vehicle 100, according to the innovative method.

The programme P comprises routines for guiding the torque build-up towards a power train torque demanded Tqreq. It comprises routines for responding to continuous torque build-up at a certain engine speed by only providing a reduced power train torque Tqlimit which is less than a maximum available engine torque Tqmax. Said programme comprises routines for continuously deciding whether the vehicle is moving or not. It comprises routines for further increasing the power train torque by increasing the engine's speed Es if the prevailing power train torque Tq is substantially the same as the reduced power train torque Tqlimit and the vehicle is not moving. It comprises routines for automatically activating said clutch configuration to non-slipping operation. It comprises routines for providing said reduced power train torque Tqlimit on the basis of a predetermined relationship between Tqlimit and Tqmax. It comprises routines for providing said reduced power train torque Tqlimit on the basis of a dynamic relationship between Tqlimit and Tqmax.

The programme P may be stored in an executable form or in compressed form in a memory 560 and/or in a read/write memory 550.

Where the data processing unit 510 is described as performing a certain function, it means that it conducts a certain part of the programme stored in the memory 560, or a certain part of the programme stored in the read/write memory 550.

The data processing device 510 can communicate with a data port 599 via a data bus 515. The non-volatile memory 520 is intended for communication with the data processing unit 510 via a data bus 512. The separate memory 560 is intended to communicate with the data processing unit via a data bus 511. The read/write memory 550 is adapted to communicating with the data processing unit via a data bus 514. The data port may for example have the links L210, L230, L235 and L240 connected to it (see FIG. 2).

When data are received on the data port 599, they are stored temporarily in the second memory element 540. When input data received have been temporarily stored, the data processing unit 510 is adapted to conducting code execution as described above. In one version, signals received on the data port contain information about a power train torque demanded Tqreq. The signals received on the data port may be used by the device 500 for wear-limiting torque build-up in a vehicle 100, particularly when it is being set in motion from stationary.

Parts of the methods herein described may be conducted by the device 500 by means of the data processing unit 510 which runs the programme stored in the memory 560 or the read/write memory 550. When the device 500 runs the programme, methods herein described are executed.

The foregoing description of the preferred embodiments of the present invention is provided for illustrative and descriptive purposes. It is not intended to be exhaustive, nor to restrict the invention to the variants described. Many modifications and variations will obviously suggest themselves to one skilled in the art. The embodiments have been chosen and described in order best to explain the principles of the invention and their practical applications and thus make it possible for one skilled in the art to understand the invention for different embodiments and with the various modifications appropriate to the intended use.

1. A method for wear-limiting torque build-up in a vehicle having an engine, a driven wheel, a clutch configuration and a gearbox connecting the engine to a driven wheel;
the method comprising the steps of:
demanding a power train torque;
guiding a torque build-up towards the power train torque demanded (Threq);
responding to continuing the torque build-up at a certain engine speed (Es) by providing a reduced power train torque (Tqlimit) which is less than a maximum available engine torque (Tqmax);
continuously determining whether the vehicle is moving or not;
further increasing the power train torque by increasing the engine's speed (Es) if the prevailing power train torque (Tq) is substantially the same as the reduced power train torque (Tqlimit) and the vehicle is not moving; or
if the prevailing power train torque (Tq) is substantially the same as the reduced power torque (Tqlimit) and the vehicle is moving, automatically activating the clutch configuration to a non-slipping operation.

2. A method according to claim 1, in which the certain speed (Es) is a low speed for the vehicle within a predetermined range.

3. A method according to claim 1, in which the certain speed (Es) is an idling speed of the engine.

4. A method according to claim 1, further comprising the step of providing the reduced power train torque (Tqlimit) on the basis of a predetermined relationship between the reduced power train torque and the maximum available engine torque (Tqmax).

5. A method according to claim 1, further comprising the step of providing the reduced power train torque (Tqlimit) on the basis of a dynamic relationship between the reduced power train torque and the maximum available engine torque (Tqmax).

6. A method according to claim 1, further comprising setting the vehicle in motion from stationary.

7. A device for wear-limiting torque build-up in a vehicle provided with an engine, driven wheel, a clutch configuration and a gearbox, the device comprising:
means for demanding a power train torque (Tqreq);
means for guiding the torque build-up towards the power train torque thus demanded (Tqreq);
means for responding to a continuing torque build-up at a certain engine speed (Es) by providing a reduced power train torque (Tqlimit) which is less than a maximum available engine torque (Tqmax);
means for continuously determining whether the vehicle is moving or not;
means for further increasing the power train torque (Tq) by increasing the engine's speed (Es) if the prevailing power train torque (Tq) is substantially the same as the reduced power train torque (Tqlimit) and the vehicle is not moving or in the alternative; and
means for automatically activating the clutch configuration to non-slipping operation if the prevailing power train torque (Tq) is substantially the same as the reduced power train torque (Tqlimit) and the vehicle is moving.

8. A device according to claim 7, in which the certain speed (Es) is a low speed for the vehicle within a predetermined range.

9. A device according to claim 7, in which the certain speed is an idling speed of the engine.

10. A device according to claim 7, further comprising means for providing the reduced power train torque (Tqlimit) on the basis of a predetermined relationship between the means for providing the reduced power train torque and the maximum available engine torque (Tqmax).

11. A device according to claim 7, further comprising means for providing the reduced power train torque (Tqlimit) on the basis of a dynamic relationship between the reduced power train torque and the maximum available engine torque (Tqmax).

12. A motor vehicle provided with a device according to claim 7.

13. A motor vehicle according to claim 12, which vehicle is a truck, a bus or a car.

14. (canceled)

15. A computer programme product comprising a computer programme (P) for wear-limiting torque build-up in a motor vehicle provided with an engine, a driven wheel, a clutch configuration and a gearbox; and
the product comprising a programme code stored on a non-volatile computer-readable medium for performing method steps according to claim 1 when the computer programme is run on an electronic control unit or another computer connected to the electronic control unit.
